(19) United States
(12) Patent Application Publication
(10) Pub. No.: US 2007/0009297 A1
(43) Pub. Date: Jan. 11, 2007

(54) Scanning auxiliary frame

(76) Inventors: Yueh-Ting Tung, Taipei City (TW); Chih-Hsien Wei, Taipei City (TW)

Correspondence Address: RABIN & Berdo, PC, 1101 14TH STREET, NW, SUITE 500, WASHINGTON, DC, 20005, US

(21) Appl. No.: 11/247,256

(22) Filed: Oct. 12, 2005

(30) Foreign Application Priority Data
Jul. 8, 2005 (TW) 94123294

(51) Int. Cl. G03G 15/00

(52) U.S. Cl. 399/377

(57) ABSTRACT

A scanning auxiliary frame includes a frame and a window sash hinged on the frame. There is a torsional spring close to the hinged location of the frame and window sash. The window sash is urged by the torsional spring and opened in normal condition when it is not retained by a bolt assembly located on the frame. Thus the window sash can be opened easily, to remove a document from a windowpane of the frame.

### PRIORITY STATEMENT

This Non-provisional application claims priority under 35 U.S.C. § 119(a) on Patent Application No(s). 94123294 filed in Taiwan on Jul. 8, 2005, the entire contents of which are hereby incorporated by reference.

### BACKGROUND OF THE INVENTION

1.Field of Invention

The present invention relates to a scanning auxiliary fame for image scanners and particularly to a scanning auxiliary frame for scanning penetrative documents.

2. Related Art

The techniques of using image scanners to scan reflective documents (reflective scanning) or penetrative documents (penetrative scanning) are known in the art. During scanning operation the document has to be laid without sliding or moving. This is essential for successful scanning. Sometimes using a scanning auxiliary frame is desirable. More about the scanning auxiliary frame is elaborated as follows:

Refer to FIG. 1 for a conventional technique. It is a holding device, which includes an upper frame 1 and a lower frame 2 coupled together. A loading sheet 3 with a penetrative document laid thereon can be wedged in an opening, formed between the upper frame 1 and the lower frame 2, to anchor the penetrative document. But positioning the loading sheet 3 in the opening could be difficult.

FIG. 2 illustrates another conventional technique. There is a window sash 4 to be held securely in the windowpane 5a of a frame 5 to anchor a document placed in the windowpane 5a for scanning. To remove the document from the windowpane 5a, the window sash 4 has to be removed from the windowpane 5a by forcing on an edge of the window sash 4 through an abutting recess 6. Such designs aim to disengage the latch relationship between the window sash 4 and the frame 5. It requires greater force, and therefore removing the window sash 4 is not easy.

### SUMMARY OF THE INVENTION

In view of the aforesaid problems, the primary object of the present invention is to provide a scanning auxiliary frame, which allows a window sash to turn relative to a frame to anchor a document for scanning. The window sash can be opened easily to remove the document from the windowpane of the frame.

To achieve the foregoing object, the scanning auxiliary frame according to the invention includes a frame and a window sash. The frame has a windowpane and a bolt assembly. The windowpane aims to hold a document. The window sash is hinged on the frame corresponding to the windowpane, and includes a torsional spring and a notch. The torsional spring is close to the hinge of the frame and the window sash. The notch corresponds to the bolt assembly.

When the window sash receives a force to close the windowpane, the bolt assembly is moved, and then returns to a normal retaining condition to latch the notch of the window sash to anchor the document. Meanwhile, the torsional spring is compressed. Hence the window sash is anchored by the bolt assembly, and the document is anchored for scanning.

On the other hand, when the bolt assembly receives a force and moves, it no longer latches the notch of the window sash. The notch is released, and the torsional spring urges the window sash to return to the normal open condition. By means of the torsional spring, the window sash can be turned relative to the frame and opened; hence the scanned document can be removed easily from the windowpane.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given in the illustration below only, and thus is not limitative of the present invention, wherein:

FIG. 1 is an exploded view of a conventional technique;

FIG. 2 is a schematic view of another conventional technique;

FIG. 3 is an exploded view of an embodiment of the invention;

FIG. 4 is a perspective view of an embodiment of the invention;

FIGS. 5A through 5B are schematic views of an embodiment of the invention, showing closing operations of the window sash;

FIGS. 6A through 6B are schematic views of an embodiment of the invention, showing opening operations of the window sash;

FIG. 7 is an enlarged schematic view of the bolt assembly of the invention; and

FIG. 8 is an enlarged schematic view of the window sash of the invention.

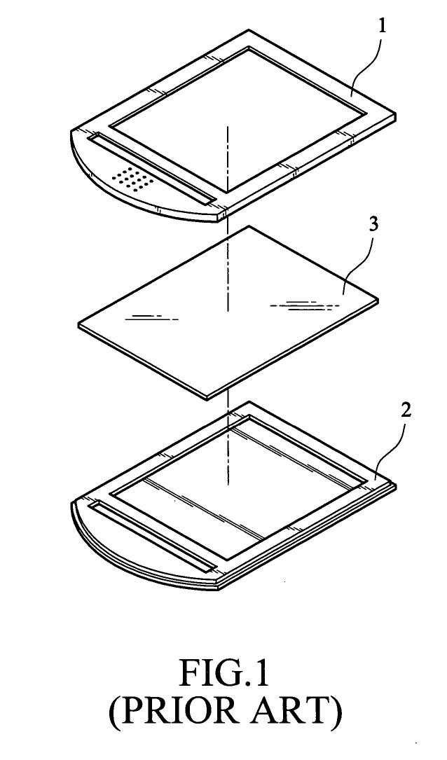

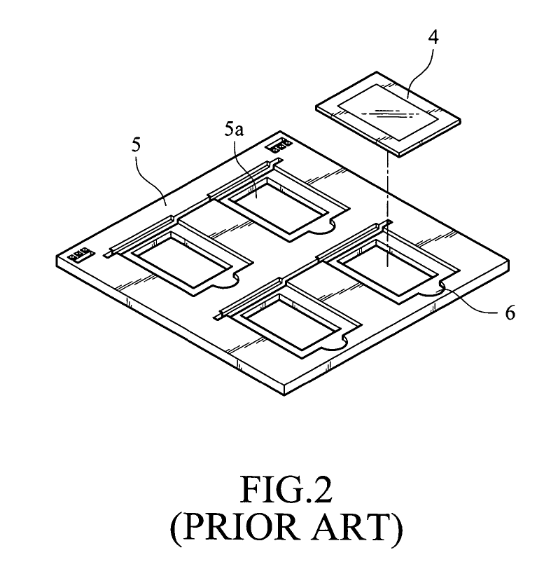

### DETAILED DESCRIPTION OF THE INVENTION

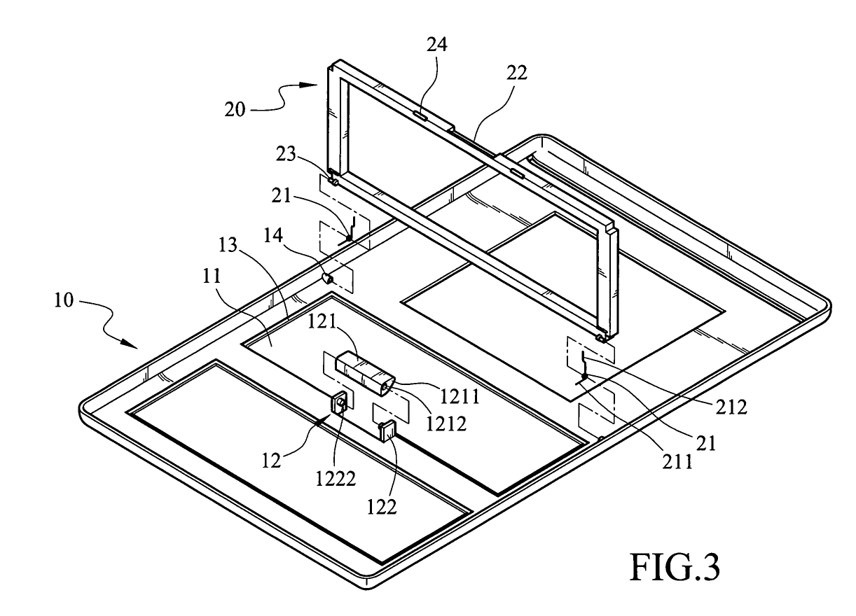

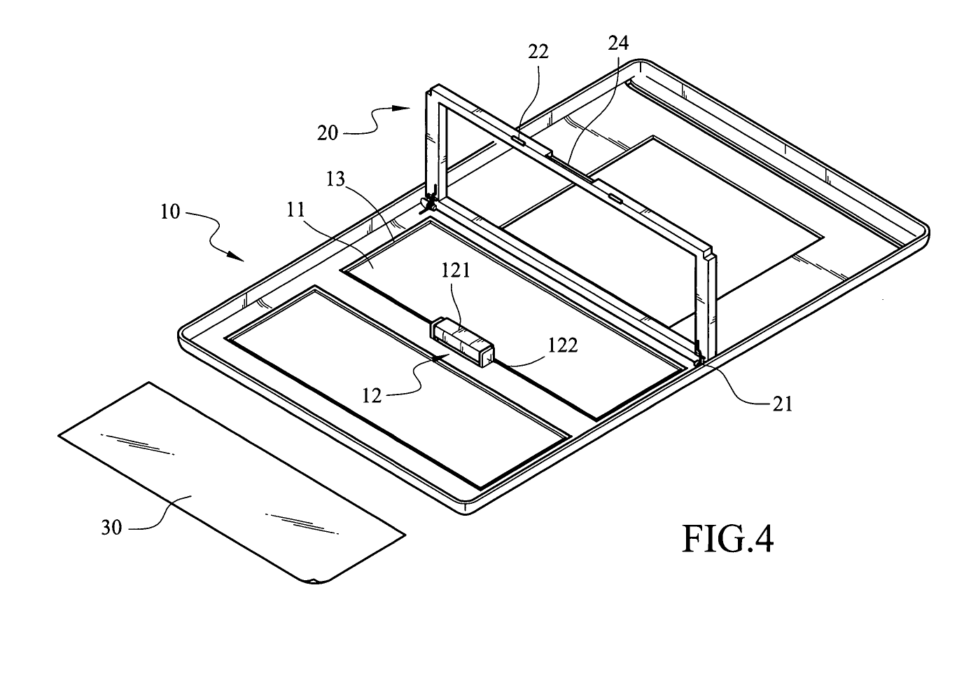

Refer to FIG. 3 for an exploded view and FIG. 4 for a perspective view of an embodiment of the invention. The scanning auxiliary frame according to the invention includes a frame 10 and a window sash 20.

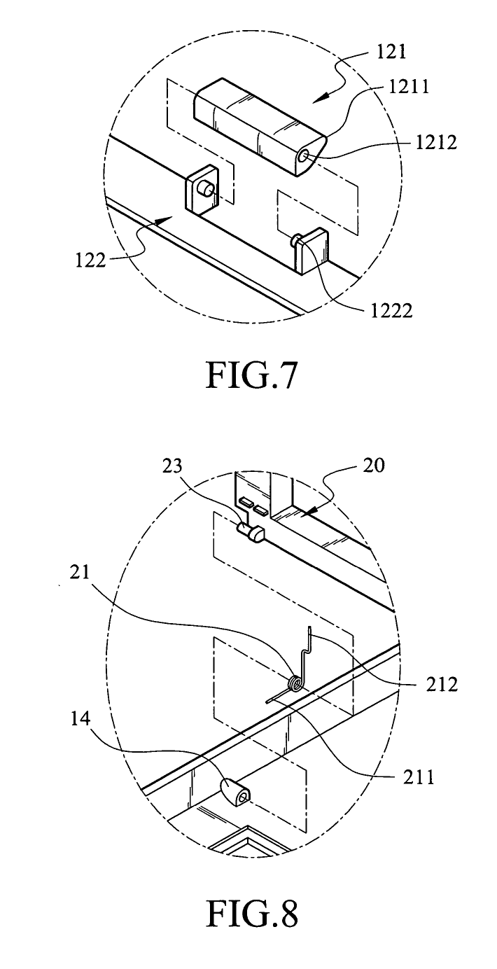

The frame 10 has a windowpane 11 and a bolt assembly 12 (also referring to FIG. 7 for an enlarged view). The frame 10 has two sides, each having a pivot aperture 14. The windowpane 11 has a holding flange 13 extended inwards for holding a document 30. The bolt assembly 12 includes a bolt 121 and a bolt seat 122. The bolt 121 is hinged on the bolt seat 122. The bolt 121 further has an arc-shaped retaining end 1211 and two pivot holes 1212 on two sides thereof. The bolt seat 122 consists of two opposing pivot plates, located on the frame 10, that have stub shafts 1222 corresponding to the pivot holes 1212.

The window sash 20 is hinged on the frame 10 corresponding to the windowpane 11. Refer to FIG. 8 for an enlarged view. The window sash 20 has torsional springs 21, a notch 22, pivot stubs 23 and latch portions 24. The torsional springs 21 are close to the hinged locations of the frame 10 and the window sash 20, and are coupled on the pivot stubs 23. Each of the torsional springs 21 has a latch end 211 to be wedged in the frame 10 and a bucking end 212 pressing the window sash 20. The notch 22 is corresponding to and mating the arc-shaped retaining end 1211. The pivot stubs 23 are located on two sides of the window sash 20 corresponding to and hinged in the pivot apertures 14. The latch portions 24 are located on the edge of the window sash 20, to be retained by the windowpane 11. The retaining force on the latch portion 24 is smaller than the returning force of the compressed torsional spring 21.

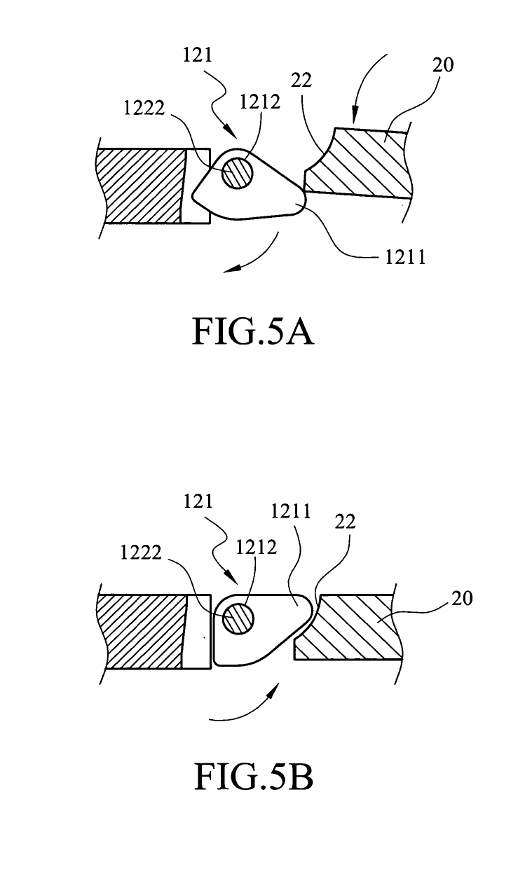

Refer to FIGS. 5A to 5B for the closing operations of the window sash. First, the document 30 is placed on the holding flange 13; the window sash 20 receives a force, with the pivot stubs 23 turning about the pivot apertures 14, it closes the windowpane 11; the retaining end 1211 of the bolt 121 is nudged, so that the pivot holes 1212 of the bolt 121 are turned about the stub shafts 1222 of the holt seat 122; after the window sash 20 has closed the windowpane 11 and compressed the document 30 on the holding flange 13, the latch portions 24 are retained by the edge of the windowpane 11. As the notch 22 corresponds to the bolt 121, when the bolt 121 returns to the normal retaining condition, it engages with the notch 22 of the window sash 20. Therefore the document 30 is anchored on the holding flange 13 to be scanned. Meanwhile, the torsional spring 21 is compressed, and the bucking end 212 is turned relative to the latch end 211 to store an elastic return force.

Hence if the exerting force is greater than the torsional spring 21, the window sash 20 can be easily anchored on the frame 10 without many operation procedures.

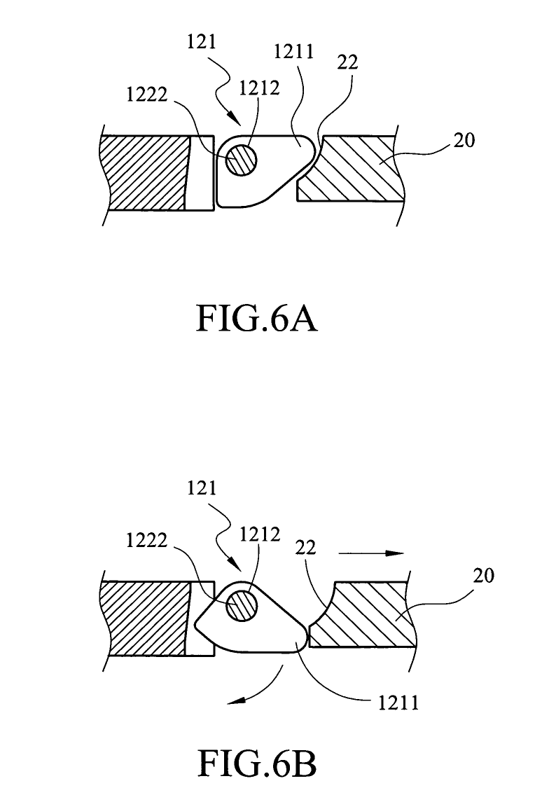

Refer to FIGS. 6A to 6B for the opening operations of the window sash. When the bolt 121 receives a force and is moved, the elastic return force of the compressed torsional spring 21 will be greater than the retaining force on the latch portions 24, hence the notch 22 will be released by the retaining end 1211, and the latch portions 24 will also be no longer retained by the edge of the windowpane 11. Moreover, the bucking end 212 of the torsional spring 21 turns relative to the latch end 211 so that the window sash 20 turns about the pivot stubs 23 in the pivot apertures 14 to the normal open condition. Thus the window sash 20 no longer presses the document 30, and which can be removed from the windowpane 11.

Therefore, once the bolt 121 is subject to force and be moved, the window sash 20 can return to the normal open condition due to the elastic return force stored in the torsional spring 21. Opening the window sash 20 is easier. The operation space used by the invention also is smaller.

Of course, the locations of the pivot apertures 14 and the pivot stubs 23, and the locations of the pivot holes 1212 and stub shafts 1222 are interchangeable respectively.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A scanning auxiliary frame, comprising:
a frame which has a windowpane, and
a window sash which is hinged on the frame and corresponds to the windowpane.

2. The scanning auxiliary frame of claim 1, wherein the frame has a bolt assembly and the window sash has a torsional spring and a notch, and the torsional spring closes to the hinged location of the frame and the window sash, and the notch corresponds to the bolt assembly.

3. The scanning auxiliary frame of claim 2, wherein the bolt assembly includes a bolt and a bolt seat located on the frame, and the bolt has two sides hinged on the bolt seat and a retaining end corresponding to the notch.

4. The scanning auxiliary frame of claim 3, wherein the bolt has two pivot holes, and the bolt seat includes two opposing pivot plates each having a stub shaft corresponding to one of the pivot holes.

5. The scanning auxiliary frame of claim 3, wherein the bolt includes two stub shafts, and the bolt seat including two opposing pivot plates each having a pivot hole corresponding to one of the stub shafts.

6. The scanning auxiliary frame of claim 3, wherein the retaining end is formed in the shape of arc and the notch corresponds to the arc-shaped retaining end.

7. The scanning auxiliary frame of claim 1, wherein the window sash has two sides each having a pivot stub, and the frame has two sides each having a pivot aperture corresponding to the pivot stub.

8. The scanning auxiliary frame of claim 7, wherein the window sash has a torsional spring, and the torsional spring is coupled on the pivot stub and includes a latch end wedged in the frame and a bucking end pressing the window sash.

9. The scanning auxiliary frame of claim 1, wherein the window sash has two sides each having a pivot aperture, and the frame has two sides each having a pivot stub corresponding to the pivot aperture.

10. The scanning auxiliary frame of claim 9, wherein the window sash has a torsional spring, and the torsional spring is coupled on the pivot stub and includes a latch end wedged in the frame and a bucking end pressing the window sash.

11. The scanning auxiliary frame of claim 1, wherein the windowpane has a holding flange extended inwards for holding a document, and the window sash is allowed to close the windowpane to anchor the document which is sandwiched between the holding flange and the window sash.

12. The scanning auxiliary frame of claim 1, wherein the window sash has a torsional spring and includes a latch portion on an edge thereof, and the latch portion is retained by another edge of the windowpane after the window sash having closed the windowpane and anchored a document, and the compressed torsional spring storing a returning elastic force greater than a retaining force of the latch portion.
